(19) United States
(12) Patent Application Publication
(10) Pub. No.: US 2012/0180754 A1
(43) Pub. Date: Jul. 19, 2012

(54) Electromagnetic Fuel Injection Valve and Internal Combustion Engine Control Device Using the Same

(75) Inventors: Atsushi Takaoku, Hitachinaka (JP); Motoyuki Abe, Mito (JP); Yasuo Namaizawa, Naka (JP)

(73) Assignee: Hitachi Automotive Systems, Ltd., Hitachinaka-shi (JP)

(21) Appl. No.: 13/348,183

(22) Filed: Jan. 11, 2012

(30) Foreign Application Priority Data
Jan. 14, 2011 (JP) 2011-006169

(51) Int. Cl. F02D 41/30; F02M 61/20

(52) U.S. Cl. 123/294; 239/533.9

(57) ABSTRACT

Disclosed is an electromagnetic fuel injection valve capable of reducing dynamic flow variation relative to the pulse widths of individual units in a lower pulse region than under idling conditions under which the dynamic flow is adjusted. Also disclosed is an internal combustion engine control device that utilizes the electromagnetic fuel injection valve. The electromagnetic fuel injection valve includes a fixed core, a coil disposed at the periphery of the fixed core, an anchor facing the lower end of the fixed core, a movable element with a valve seat formed on its lower end, and a regulator press-fit into a through-hole in the fixed core, the fixed core being a central shaft of the electromagnetic fuel injection valve.

### BACKGROUND OF THE INVENTION

1. Field of the Invention

The present invention relates to an electromagnetic fuel injection valve and to an internal combustion engine control device using the same. More specifically, the invention relates to an electromagnetic fuel injection valve suitable for an automotive direct injection gasoline engine and to an internal combustion engine control device using the same.

2. Description of the Related Art

It is demanded that an electromagnetic fuel injection valve utilized in an internal combustion engine, or more particularly, in a direct fuel injection system, cover a wide control range from a low flow rate to a high flow rate in order to comply with exhaust gas/fuel efficiency regulations and requirements. As such being the case, the electromagnetic fuel injection valve makes dynamic flow adjustments with an internal flow adjustment mechanism to suppress, as needed, unit-to-unit flow rate variation, which is caused, for instance, by dimensional variation, and permit the flow rate to be controlled in accordance with an input pulse width. If, in the above instance, the flow rate significantly varies from one unit to another, a combustion state varies from one cylinder to another, thereby increasing the vibration and noise of the engine and producing unburned hydrocarbon and soot in exhaust gas.

Under the above circumstances, the dynamic flow adjustments were generally made in the past in accordance with a pulse width and flow rate prevailing under idling conditions so that the unit-to-unit flow rate variation during idling could be minimized to reduce the vibration and noise during idling (refer, for instance, to JP-2004-150344-A).

### SUMMARY OF THE INVENTION

However, if an automobile is accelerated after running with fuel cut off in a particular running mode selected, for instance, for downhill running, the automobile runs in a lower-load, lower-revolution-speed state than during idling. It means that the required flow rate is lower than that for idling. Therefore, even when fuel is injected at a controllable minimum flow rate, the automobile receives an acceleration shock due to a sharp increase in the revolution speed of the engine.

Further, if the flow rate significantly varies from one electromagnetic fuel injection valve to another, the combustion state varies from one cylinder to another, causing the engine to considerably vibrate. Therefore, stable acceleration is not implemented due to variation in the engine revolution speed. This results in an increase in the amount of unburned hydrocarbon and soot produced in exhaust gas.

Meanwhile, JP-2004-150344-A discloses the invention in which the dynamic flow is adjusted under idling conditions. Therefore, a deviation from the pulse width prevailing under idling conditions under which the dynamic flow is adjusted would increase the unit-to-unit flow rate variation. Particularly when the flow rate is lower than under idling conditions, the dynamic flow variation relative to the pulse width is immensely influenced as the absolute value of the flow rate is small.

An object of the present invention is to provide an electromagnetic fuel injection valve capable of reducing the dynamic flow variation relative to the pulse widths of individual units in a lower pulse region than under idling conditions under which the dynamic flow is adjusted. Another object of the present invention is to provide an internal combustion engine control device that utilizes the electromagnetic fuel injection valve.

(1) In accomplishing the above objects, according to a first aspect of the present invention, there is provided an electromagnetic fuel injection valve including a fixed core, a coil, an anchor, a movable element, a valve seat, a regulator, and a spring. The coil is disposed at the periphery of the fixed core. The anchor faces the lower end of the fixed core. The valve seat is formed on the lower end of the movable element. The regulator is press-fit into a through-hole in the fixed core, the fixed core being a central shaft of the electromagnetic fuel injection valve. The spring is disposed so that the upper end thereof is fixed in axial direction by the regulator while the lower end is positioned to press the movable element toward the valve seat. A magnetic attractive force is generated by energizing the coil in order to attract the anchor and the movable element to the fixed core. The regulator is adjusted so that a dynamic flow q0 is high within a tolerance of ±x % of a target dynamic flow qm when a static flow Qst is high within a tolerance of ±y % of a target static flow Qstm while the dynamic flow q0 is low within a tolerance of ±x % of the target dynamic flow qm when the static flow Qst is low within a tolerance of ±y % of the target static flow Qstm.

The above-described configuration makes it possible to reduce the dynamic flow variation relative to the pulse widths of individual units in a lower pulse region than under idling conditions under which the dynamic flow is adjusted.

(2) According to the first aspect of the present invention, there is provided the electromagnetic fuel injection valve, wherein, when adjusted, the dynamic flow q0 is equal to qm÷Qstm×Qst÷y×x.

(3) In accomplishing the above objects, according to a second aspect of the present invention, there is provided an internal combustion engine control device that is utilized for an internal combustion engine having an electromagnetic fuel injection valve for directly injecting fuel into a combustion chamber of the internal combustion engine and operated to control a fuel injection operation by the electromagnetic fuel injection valve. A regulator included in the electromagnetic fuel injection valve is adjusted so that a dynamic flow q0 is high within a tolerance of ±x % of a target dynamic flow qm when a static flow Qst is high within a tolerance of ±y % of a target static flow Qstm while the dynamic flow q0 is low within a tolerance of ±x % of the target dynamic flow qm when the static flow Qst is low within a tolerance of ±y % of the target static flow Qstm. In a low-load, low-revolution-speed operating state of the internal combustion engine, the electromagnetic fuel injection valve is controlled in accordance with a pulse width prevailing below an idling point.

The above-described configuration makes it possible to reduce the dynamic flow variation relative to the pulse widths of individual units in a lower pulse region than under idling conditions under which the dynamic flow is adjusted. Therefore, fuel flow rate control can be accurately exercised even in a low-revolution-speed region below the idling point.

(4) According to the second aspect of the present invention, there is provided the internal combustion engine control device, wherein the electromagnetic fuel injection valve is configured so that when adjusted, the dynamic flow q0 is equal to qm÷Qstm×Qst÷y×x.

Embodiments of the present invention makes it possible to reduce the dynamic flow variation relative to the pulse widths of individual units in a pulse region lower than the idling conditions under which the dynamic flow is adjusted.

### BRIEF DESCRIPTION OF THE DRAWINGS

FIG. 1 is a cross-sectional view illustrating the configuration of an electromagnetic fuel injection valve according to a first embodiment of the present invention.

FIG. 2 is a diagram illustrating an operation of the electromagnetic fuel injection valve according to the first embodiment of the present invention.

FIG. 3 is a diagram illustrating the flow rate characteristics of the electromagnetic fuel injection valve according to the first embodiment of the present invention.

FIG. 4 is a diagram illustrating the flow rate characteristics of the electromagnetic fuel injection valve according to the first embodiment of the present invention.

FIG. 5 is a diagram illustrating a comparative example of the flow rate characteristics of the electromagnetic fuel injection valve.

FIG. 6 is a diagram illustrating the comparative example of the flow rate characteristics of the electromagnetic fuel injection valve.

FIG. 7 is a block diagram illustrating the configuration of a dynamic flow variation adjustment device for the electromagnetic fuel injection valve according to a second embodiment of the present invention.

FIG. 8 is a diagram illustrating the adjustment principle of the dynamic flow variation adjustment device for the electromagnetic fuel injection valve according to the second embodiment of the present invention.

FIG. 9 is a block diagram illustrating the configuration of an internal combustion engine system that utilizes the electromagnetic fuel injection valve according to the first or second embodiment of the present invention.

### DESCRIPTION OF THE PREFERRED EMBODIMENTS

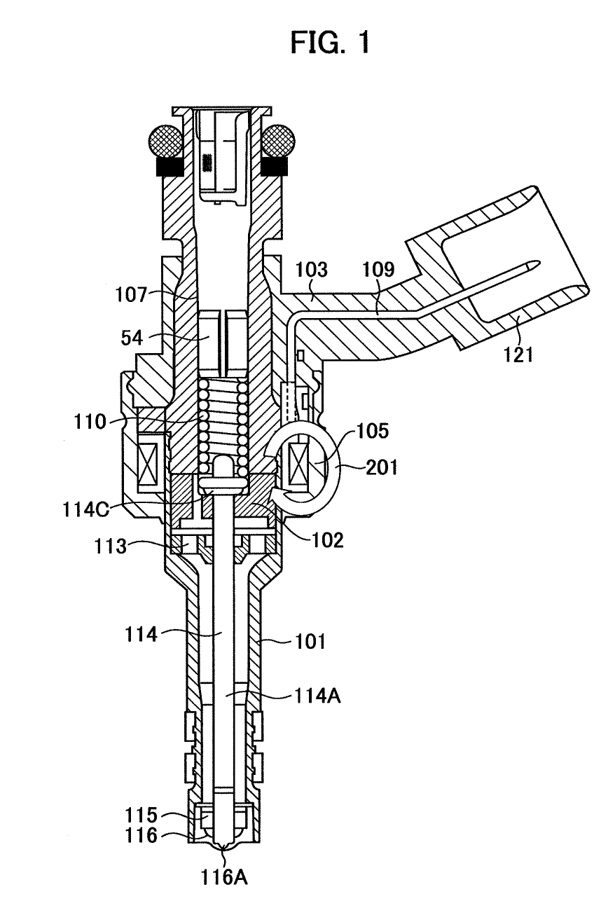

The configuration and flow rate adjustment method of an electromagnetic fuel injection valve according to a first embodiment of the present invention will now be described with reference to FIGS. 1 to 6.

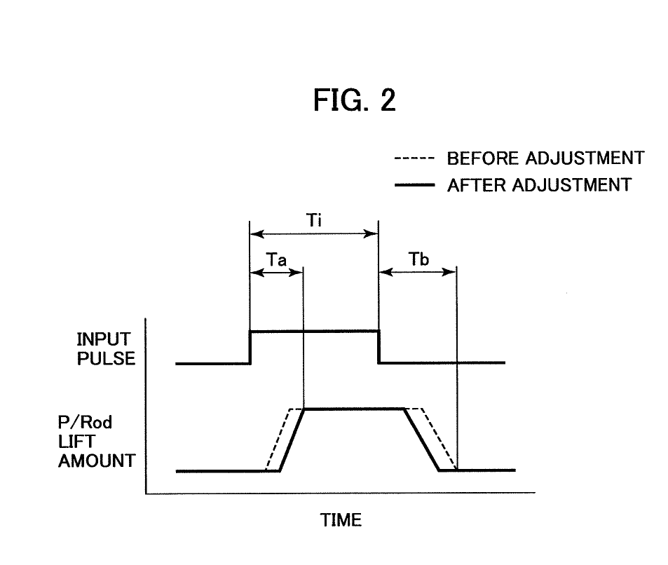

First of all, the configuration of the electromagnetic fuel injection valve according to the first embodiment will be described reference to FIGS. 1 and 2.

FIG. 1 is a cross-sectional view illustrating the configuration of the electromagnetic fuel injection valve according to the first embodiment of the present invention.

FIG. 2 is a diagram illustrating an operation of the electromagnetic fuel injection valve according to the first embodiment of the present invention.

In the electromagnetic fuel injection valve according to the present embodiment, the upper end of a valve disc 114 is provided with a head 114C that includes a stepped portion having a larger outside diameter than a diameter of a rod 114A. The head 114C is provided with a seating surface for a spring 110.

The periphery of the rod 114A is retained by a guide member 115 and a movable element guide 113 in such a manner as to permit the periphery to make an up-down straight reciprocating motion.

While an electromagnetic coil 105 is de-energized to close the valve, the biasing force of the spring 110 causes the leading end of the valve disc 114 to abut against an orifice cup (valve seat) 116, thereby shutting off the supply of fuel to a fuel injection hole 116A.

The electromagnetic coil 105 is disposed at the periphery of a fixed core 107. A toroidally-shaped magnetic path 201, which is indicated by an arrow 201, is formed through an anchor 102, which is integrally press-fit to a housing 103, a nozzle 101, and the valve disc 114.

The electromagnetic coil 105 is configured so that a connector 121 formed at the leading end of a conductor 109 is connected to a plug to which a battery voltage is applied to supply electrical power. A controller (not shown) exercises control to determine whether or not to supply electrical power to the electromagnetic coil 105.

While the electromagnetic coil 105 is energized, a magnetic flux passing through the magnetic path 201 generates a magnetic attractive force in a magnetic gap between the fixed core 107 and the anchor 102, which faces the lower end of the fixed core 107. When attracted by a force greater than a load predefined for the spring 110, the anchor 102 moves upward until it collides against the lower end face of the fixed core 107. As a result, the leading end of the valve disc 114 leaves the orifice cup 116 to open the valve so that the fuel supplied from a through-hole at the center of the fixed core 107, which serves as a fuel path, is injected into a combustion chamber from the fuel injection hole 116A.

When the electromagnetic coil 105 is de-energized, the magnetic flux in the magnetic path 201 disappears, thereby causing the magnetic attractive force in the magnetic gap to disappear as well. In this state, the force of the spring 110, which presses the valve disc 114 in a valve closing direction, is exerted on movable elements (anchor 102 and valve disc 114). As a result, the leading end of the valve disc 114 is pushed back to a valve closing position at which it is brought into contact with the orifice cup 116.

A regulator 54 abuts against an upper end face of the spring 110 that is positioned opposite the valve disc 114. The regulator 54 is securely press-fit into the inside diameter portion of the fixed core 107. The biasing force of the spring 110 that is applied to the valve disc 114 can be adjusted by changing the depth to which the regulator 54 is press-fit into the fixed core 107 from its upper end face. The regulator 54 can be rotated while the leading end of a flat-blade screwdriver is engaged with a groove in its upper end. The depth to which the regulator 54 is press-fit into the fixed core 107 from its upper end face can be changed by rotating the regulator 54.

The relationship between an input pulse for the controller and the lift amount of the valve disc 114 will now be described with reference to FIG. 2. When the input pulse for the controller turns on, the electromagnetic coil 105 becomes energized. When a valve opening delay time Ta elapses after the electromagnetic coil 105 is energized, the valve disc 114 opens. When the input pulse turns off, the valve disc 114 closes after the elapse of a valve closing delay time Tb. Here, it is assumed that the pulse width of the input pulse is Ti.

When the regulator 54 increases the biasing force of the spring 110, the force applied to the valve disc 114 in the valve closing direction increases. This increases the valve opening delay time Ta and decreases the valve closing delay time Tb so that the result is similar to the dotted line in FIG. 2. The period of time during which the valve remains open then decreases even when the pulse width Ti remains unchanged. This decreases a dynamic flow q, which represents a flow rate obtained upon single injection.

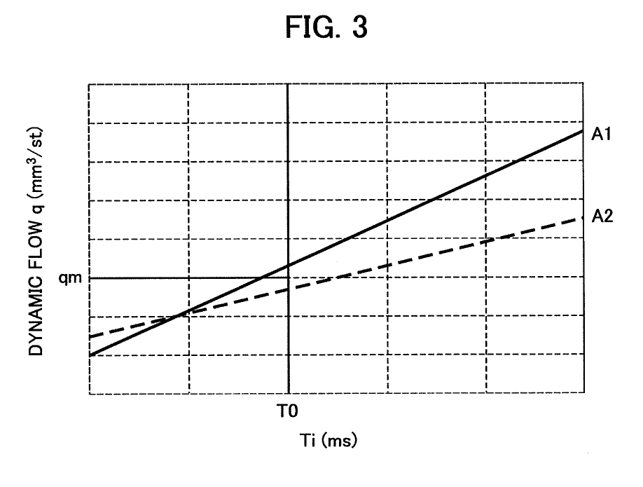

A flow rate adjustment method of the electromagnetic fuel injection valve according to the first embodiment of the present invention will now be described with reference to FIGS. 3 to 6.

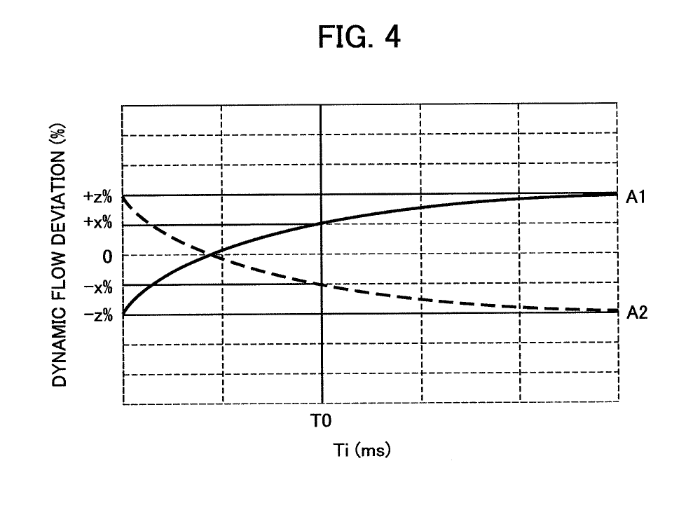

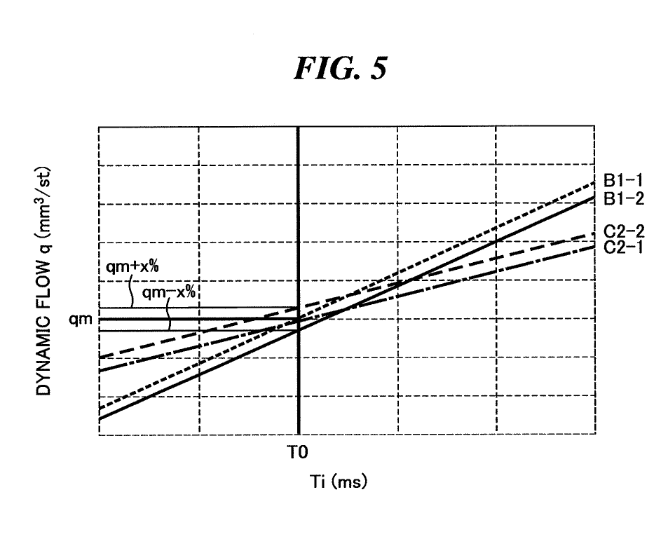

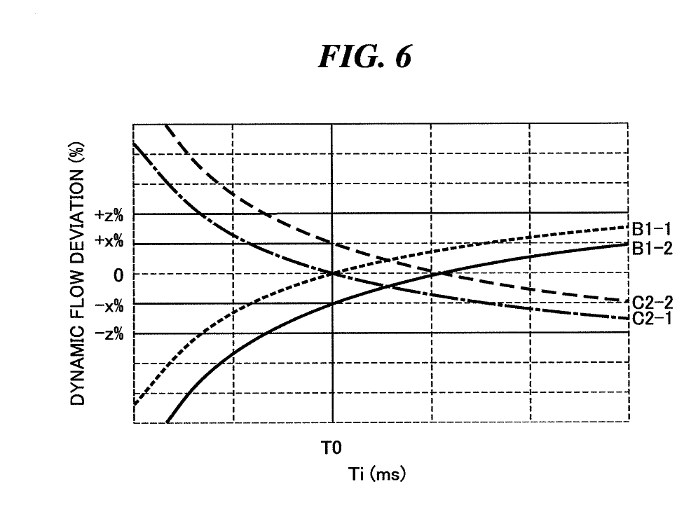

FIGS. 3 and 4 are diagrams illustrating the flow rate characteristics of the electromagnetic fuel injection valve according to the first embodiment of the present invention. FIGS. 5 and 6 are diagrams illustrating a comparative example of the flow rate characteristics of the electromagnetic fuel injection valve.

Here, it is assumed that an injection rate indicative of a flow rate prevailing while the electromagnetic fuel injection valve shown in FIG. 1 is fully lifted is a static flow Qst. The static flow Qst varies due to the variation in the full lift amount of the valve disc 114 and the variation in the flow path area of the fuel injection hole 116A. The static flow Qst is defined to be within a tolerance of ±y % of a target static flow value Qstm. To further reduce the static flow variation, it is necessary to increase the dimensional accuracies of relevant parts. However, such dimensional accuracy enhancement is difficult to achieve because it makes it necessary to invest in equipment and provide increased machining time.

Therefore, the static flow Qst of every manufactured fuel injection valve is measured. Fuel injection valves are accepted as conforming products if their measured value is within a tolerance of ±y % of the target static flow value Qstm, and subjected to dynamic flow adjustments described below. While fuel injection valves whose measured value is outside a tolerance of ±y % of the target static flow value Qstm are rejected as nonconforming products.

Conventionally, the dynamic flow is adjusted as described below. First of all, the dynamic flow is adjusted in accordance with a pulse width and target flow rate prevailing under idling conditions to minimize unit-to-unit flow rate variation during idling for the purpose of reducing vibration and noise during idling.

Fuel injection valves whose measured value is within a tolerance of ±y % of the target static flow value Qstm are subjected to flow rate measurements. While the flow rate measurements are being conducted, the unit-to-unit variation encountered during a manufacturing process is suppressed by adjusting the dynamic flow. The dynamic flow is adjusted by adjusting the press-fit position of the regulator 54 until a dynamic flow q0 at a pulse width T0 at a dynamic flow adjustment point is within a tolerance of ±x % of a target dynamic flow qm. The pulse width T0 at the dynamic flow adjustment point is the pulse width prevailing under the idling conditions. In other words, the dynamic flow adjustments are complete when the dynamic flow q0 at the pulse width T0 at the dynamic flow adjustment point is within a tolerance of ±x % of the target dynamic flow qm. In the above instance, no particular attention is paid to the value of the dynamic flow q0 at the pulse width T0 at the dynamic flow adjustment point as far as it is within a tolerance of ±x % of the target dynamic flow qm.

Meanwhile, the present embodiment, the dynamic flow is adjusted as described below.

As described above, fuel injection valves are accepted as conforming products if their measured static flow Qst is within a tolerance of ±y % of the target static flow value Qstm, and subjected to dynamic flow adjustments. Therefore, 1) fuel injection valves whose measured static flow Qst is equal to the target static flow value Qstm +y % and 2) fuel injection valves whose measured static flow Qst is equal to the target static flow value Qstm −y % are both subjected to the dynamic flow adjustments. In the present embodiment, the adjustment point for the dynamic flow adjustments varies in accordance with static flow characteristics.

More specifically, the dynamic flow is adjusted so that the dynamic flow q0 at the pulse width T0 at the dynamic flow adjustment point is within a tolerance of ±x % of the target dynamic flow qm. In such an instance, 1) the regulator 54 is adjusted so that the dynamic flow q0 of an electromagnetic fuel injection valve whose measured static flow Qst is higher than the target static flow Qstm is increased within a tolerance of ±x % of the target dynamic flow qm, and 2) the regulator 54 is adjusted so that the dynamic flow q0 of an electromagnetic fuel injection valve whose measured static flow Qst is lower than the target static flow Qstm is decreased within a tolerance of ±x % of the target dynamic flow qm.

A case where the dynamic flow is adjusted as described above and a case where the dynamic flow is adjusted in a conventional manner will now be described with reference to FIGS. 3 to 6.

Referring to FIG. 3, the horizontal axis indicates the pulse width T (mS) applied to a fuel injection valve, and the vertical axis indicates the dynamic flow q (mm³/st). As for the dynamic flow q, the symbol “st” is utilized to indicate the flow rate per stroke of the valve disc 114 shown in FIG. 1.

The relationship between the dynamic flow q and pulse width Ti, which is shown in FIG. 3, is expressed by Equation (1) below:

q=Qst×(Ti−T0)+q0 (1)

Referring to FIG. 3, a solid line A1 represents an electromagnetic fuel injection valve whose measured static flow Qst is higher than the target static flow Qstm, that is, an electromagnetic fuel injection valve whose measured static flow Qst is equal to the target static flow value Qstm+y %. For such a fuel injection valve, the regulator 54 is adjusted so that the dynamic flow q0 at the pulse width T0 at the dynamic flow adjustment point is equal to the target dynamic flow qm+x %.

Meanwhile, a broken line A2 represents an electromagnetic fuel injection valve whose measured static flow Qst is lower than the target static flow Qstm, that is, an electromagnetic fuel injection valve whose measured static flow Qst is equal to the target static flow value Qstm−y %. For such a fuel injection valve, the regulator 54 is adjusted so that the dynamic flow q0 at the pulse width T0 at the dynamic flow adjustment point is equal to the target dynamic flow qm-x %.

A dynamic flow deviation prevailing when the dynamic flow is adjusted as shown in FIG. 3 will now be described with reference to FIG. 4.

As described with reference to FIG. 3, the regulator 54 for a fuel injection valve having characteristics indicated by the solid line A1 is adjusted so that the dynamic flow q0 at the pulse width T0 at the dynamic flow adjustment point has an error (deviation) of +x %. FIG. 4 relates to a fuel injection valve adjusted in the above manner and shows the relationship between the pulse width T and an error encountered at the pulse width T.

The dynamic flow deviation at a pulse width T1, which is smaller than the pulse width T0 at the dynamic flow adjustment point by a pulse width ΔT1, is −z %.

As described with reference to FIG. 3, the regulator 54 for a fuel injection valve having characteristics indicated by the broken line A2 is adjusted so that the dynamic flow q0 at the pulse width T0 at the dynamic flow adjustment point has an error (deviation) of −x %. FIG. 4 relates to a fuel injection valve adjusted in the above manner and shows the relationship between the pulse width T and an error encountered at the pulse width T.

Further, the dynamic flow deviation at the pulse width T1, which is smaller than the pulse width T0 at the dynamic flow adjustment point by the pulse width ΔT1, is +z %.

A comparative example will now be described with reference to FIGS. 5 and 6.

Referring to FIG. 5, the horizontal axis indicates the pulse width T (mS) applied to a fuel injection valve, and the vertical axis indicates the dynamic flow q (mm³/st), as is the case with FIG. 3.

In FIG. 5, a dotted line B1-1 and a solid line B1-2 represent electromagnetic fuel injection valves whose measured static flow Qst is higher than the target static flow Qstm, that is, electromagnetic fuel injection valves whose measured static flow Qst is equal to the target static flow value Qstm+y %.

For such fuel injection valves, the regulator 54 is adjusted so that the dynamic flow q0 at the pulse width T0 at the dynamic flow adjustment point is equal to the target dynamic flow qm±x %. As a result, for a fuel injection valve represented by the dotted line B1-1, it is assumed that the dynamic flow q0 at the pulse width T0 at the dynamic flow adjustment point is equal to the target dynamic flow qm-x %.

For a fuel injection valve represented by the solid line B1-2, it is assumed that the dynamic flow q0 at the pulse width T0 at the dynamic flow adjustment point is equal to the target dynamic flow qm±0%.

A one-dot chain line C2-1 and a broken line C2-2 represent electromagnetic fuel injection valves whose measured static flow Qst is lower than the target static flow Qstm, that is, electromagnetic fuel injection valves whose measured static flow Qst is equal to the target static flow value Qstm−y %.

For such fuel injection valves, the regulator 54 is adjusted so that the dynamic flow q0 at the pulse width T0 at the dynamic flow adjustment point is equal to the target dynamic flow qm±x %. As a result, for a fuel injection valve represented by the one-dot chain line C2-1, it is assumed that the dynamic flow q0 at the pulse width T0 at the dynamic flow adjustment point is equal to the target dynamic flow qm+x %.

For a fuel injection valve represented by the broken line C2-2, it is assumed that the dynamic flow q0 at the pulse width T0 at the dynamic flow adjustment point is equal to the target dynamic flow qm±0%.

FIG. 6 shows the dynamic flow deviation of the comparative example of a fuel injection valve that is adjusted for characteristics indicated by the line B1-1, B1-2, C2-1, or C2-2 shown in FIG. 5.

As described with reference to FIG. 5, for a fuel injection valve having characteristics indicated by the dotted line B1-1, the regulator 54 is adjusted so that the dynamic flow q0 at the pulse width T0 at the dynamic flow adjustment point has an error (deviation) of −x %. FIG. 6 relates to a fuel injection valve adjusted in the above manner and shows the relationship between the pulse width T and an error encountered at the pulse width T.

The dynamic flow deviation at a pulse width T2, which is smaller than the pulse width T0 at the dynamic flow adjustment point by a pulse width ΔT2, is −z %.

As described with reference to FIG. 5, for a fuel injection valve having characteristics indicated by the one-dot chain line C2-1, the regulator 54 is adjusted so that the dynamic flow q0 at the pulse width T0 at the dynamic flow adjustment point has an error (deviation) of +x %. FIG. 6 relates to a fuel injection valve adjusted in the above manner and shows the relationship between the pulse width T and an error encountered at the pulse width T.

Further, the dynamic flow deviation at the pulse width T2, which is smaller than the pulse width T0 at the dynamic flow adjustment point by the pulse width ΔT2, is +z %.

As described with reference to FIG. 5, for a fuel injection valve having characteristics indicated by the solid line B1-2, the regulator 54 is adjusted so that the dynamic flow q0 at the pulse width T0 at the dynamic flow adjustment point has an error (deviation) of ±0x %. FIG. 6 relates to a fuel injection valve adjusted in the above manner and shows the relationship between the pulse width T and an error encountered at the pulse width T.

Further, the dynamic flow deviation at a pulse width T3, which is smaller than the pulse width T0 at the dynamic flow adjustment point by a pulse width ΔT3, is −z %.

As described with reference to FIG. 5, for a fuel injection valve having characteristics indicated by the broken line C2-2, the regulator 54 is adjusted so that the dynamic flow (40 at the pulse width T0 at the dynamic flow adjustment point has an error (deviation) of ±0x %. FIG. 6 relates to a fuel injection valve adjusted in the above manner and shows the relationship between the pulse width T and an error encountered at the pulse width T.

Further, the dynamic flow deviation at the pulse width T3, which is smaller than the pulse width T0 at the dynamic flow adjustment point by the pulse width ΔT3, is +z %.

When FIGS. 4 and 6 are compared to investigate the pulse width T at which the dynamic flow deviation is not greater than ±z %, it is found that dynamic flow variation can be reduced even in a lower flow rate region when dynamic flow variation is adjusted in accordance with the present embodiment, which is shown in FIG. 4, than when dynamic flow variation is adjusted in accordance with the comparative example shown in FIG. 6. In other words, it makes possible to reduce the dynamic flow variation relative to the pulse widths of individual units in a lower pulse region than under idling conditions under which the dynamic flow is adjusted.

When the above-described dynamic flow adjustment method is utilized, unit-to-unit dynamic flow variation below an idling point can be suppressed without increasing the dimensional accuracies of relevant parts.

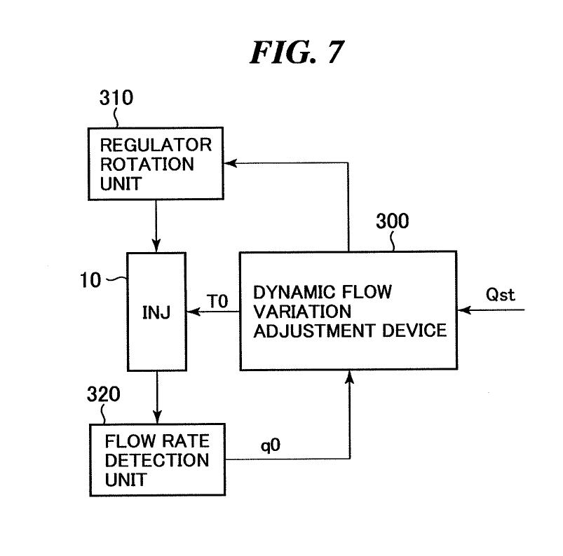

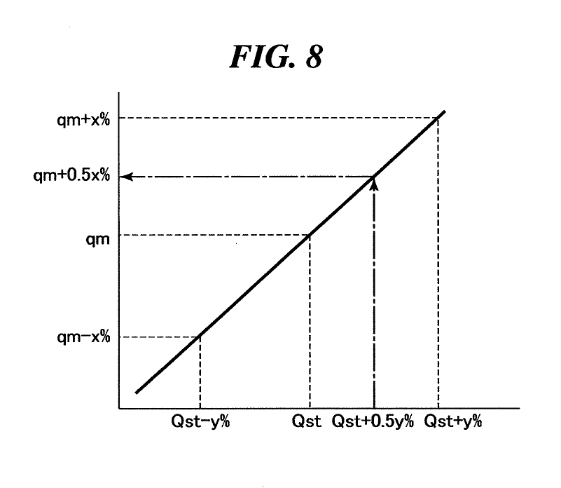

A flow rate adjustment method of the electromagnetic fuel injection valve according to a second embodiment of the present invention will now be described with reference to FIGS. 7 and 8. The electromagnetic fuel injection valve according to the second embodiment has the same configuration as shown in FIG. 1.

FIG. 7 is a block diagram illustrating the configuration of a dynamic flow variation adjustment device for the electromagnetic fuel injection valve according to the second embodiment of the present invention. FIG. 8 is a diagram illustrating the adjustment principle of the dynamic flow variation adjustment device for the electromagnetic fuel injection valve according to the second embodiment of the present invention.

In the present embodiment, the electromagnetic fuel injection valve 10 having the same configuration as shown in FIG. 1 includes a dynamic flow variation adjustment device 300, a regulator rotation unit 310, and a flow rate detection unit 320. These components included in the electromagnetic fuel injection valve 10 are utilized for adjustments of the dynamic flow variation.

The regulator rotation unit 310 includes an engagement unit such as a screwdriver, which engages with an upper groove in the regulator 54 for the electromagnetic fuel injection valve shown in FIG. 1, and a motive power source such as a motor, which rotationally drives the engagement unit.

The flow rate detection unit 320 detects the flow rate q0 of the electromagnetic fuel injection valve 10 when the dynamic flow variation adjustment device 300 applies the pulse width T0 at the dynamic flow adjustment point to the electromagnetic fuel injection valve 10.

The measured static flow Qst is input beforehand into the dynamic flow variation adjustment device 300. The input measured static flow Qst relates to an electromagnetic fuel injection valve having such characteristics that the measured static flow is equal to the target static flow value Qstm+y %.

The dynamic flow variation adjustment device 300 utilizes the regulator rotation unit 310 to rotate the regulator 54 for the electromagnetic fuel injection valve 10. The resulting adjusted flow rate q0 of the electromagnetic fuel injection valve 10 is then detected by the flow rate detection unit 320.

The dynamic flow variation adjustment device 300 operates so as to satisfy Equation (2) below:

q0=qm÷Qstm×Qst÷y×x (2)

More specifically, the dynamic flow q0 of an electromagnetic fuel injection valve whose measured static flow Qst is higher than the target static flow Qstm is increased within a tolerance of ±x % of the target dynamic flow qm, and the dynamic flow q0 of an electromagnetic fuel injection valve whose measured static flow Qst is lower than the target static flow Qstm is decreased within a tolerance of ±x % of the target dynamic flow qm.

Referring to FIG. 8, if, for instance, the measured static flow Qst is equal to the target static flow value Qstm+0.5y %, the regulator 54 is adjusted so that the dynamic flow q0 is equal to the target dynamic flow qm±0.5x %.

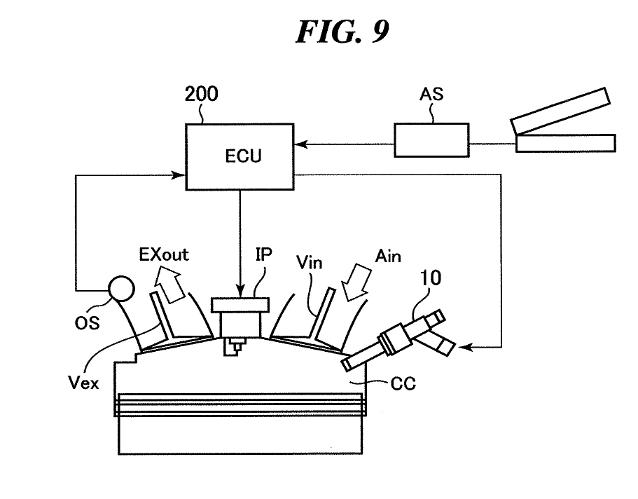

The configuration of an internal combustion engine system that utilizes the electromagnetic fuel injection valve according to the first or second embodiment of the present invention will now be described with reference to FIG. 9.

FIG. 9 is a block diagram illustrating the configuration of the internal combustion engine system that utilizes the electromagnetic fuel injection valve according to the first or second embodiment of the present invention.

First of all, the configuration of an internal combustion engine included in the internal combustion engine system will be described. An intake valve Vin and an exhaust valve Vex are disposed on the top of a combustion chamber CC of the internal combustion engine. When the intake valve Vin opens, intake air Ain is introduced into the combustion chamber through an intake pipe. When the exhaust valve Vex opens, exhaust gas EXout in the combustion chamber is discharged to the outside through an exhaust pipe.

Further, the internal combustion engine includes the electromagnetic fuel injection valve 10 that directly sprays fuel into the combustion chamber CC. A fuel spray injected from the electromagnetic fuel injection valve 10 mixes with the intake air Ain introduced through the intake pipe. The fuel spray mixed with the intake air is ignited and burned by an ignition plug IP mounted on the top of the combustion chamber. It should be noted that the fuel spray may alternatively be compression-ignited without using an ignition plug. The exhaust pipe includes an oxygen concentration sensor OS that detects the concentration of oxygen in the exhaust gas EXout.

A control device (ECU) 200 for the internal combustion engine inputs information about an accelerator pedal depression amount detected by an accelerator opening sensor AS for detecting the amount of accelerator pedal depression and information about the oxygen concentration detected by the oxygen concentration sensor OS. The information about the accelerator pedal depression amount indicates the intention of a driver. The information about the oxygen concentration indicates the operating status of a vehicle on which the internal combustion engine is mounted. The control device 200 for the internal combustion engine also inputs other information indicative of the intention of the driver and the operating status of the vehicle.

In accordance with the information indicative of the intention of the driver and the information indicative of the operating status of the vehicle, the control device 200 for the internal combustion engine controls the ignition timing of the ignition plug IP and the fuel injection timing and fuel injection amount of the electromagnetic fuel injection valve 10.

The electromagnetic fuel injection valve 10 has the configuration shown in FIG. 1. The regulator 54 for the electromagnetic fuel injection valve 10 is adjusted by the method described with reference to FIG. 2 or 7 so as to reduce the dynamic flow deviation on a low fuel side and decrease the controllable minimum flow rate. Therefore, the control device 200 for the internal combustion engine can suppress the unit-to-unit variation in the dynamic flow deviation below the idling point and accurately control the fuel flow rate even in a low-revolution-speed region below the idling point.

As described above, the above-described embodiments make it possible to reduce the dynamic flow variation relative to the pulse widths of individual units in a lower pulse region than under idling conditions under which the dynamic flow is adjusted. Consequently, the fuel flow rate can be accurately controlled even in a low-revolution-speed region below the idling point.

What is claimed is:

1. An electromagnetic fuel injection valve comprising:
a fixed core;
a coil disposed at the periphery of the fixed core;
an anchor that faces the lower end of the fixed core;
a movable element;
a valve seat formed on the lower end of the movable element;
a regulator press-fit into a through-hole in the fixed core, the fixed core being a central shaft of the electromagnetic fuel injection valve; and
a spring disposed so that the upper end of the spring is fixed in axial direction by the regulator while the lower end of the spring is positioned to press the movable element toward the valve seat;
wherein, a magnetic attractive force is generated by energizing the coil in order to attract the anchor and the movable element to the fixed core; and
wherein the regulator is adjusted so that a dynamic flow q0 is high within a tolerance of ±x % of a target dynamic flow qm when a static flow Qst is high within a tolerance of ±y % of a target static flow Qstm while the dynamic flow q0 is low within a tolerance of ±x % of the target dynamic flow qm when the static flow Qst is low within a tolerance of ±y % of the target static flow Qstm.

2. The electromagnetic fuel injection valve according to claim 1, wherein, when adjusted, the dynamic flow q0 is equal to qm±Qstm×Qst÷y×x.

3. An internal combustion engine control device that is utilized for an internal combustion engine having an electromagnetic fuel injection valve for directly injecting fuel into a combustion chamber of the internal combustion engine and operated to control a fuel injection operation by the electromagnetic fuel injection valve, the internal combustion engine control device comprising:
a regulator that is adjusted so that a dynamic flow q0 is high within a tolerance of ±x % of a target dynamic flow qm when a static flow Qst is high within a tolerance of ±y % of a target static flow Qstm while the dynamic flow q0 is low within a tolerance of ±x % of the target dynamic flow qm when the static flow Qst is low within a tolerance of ±y % of the target static flow Qstm;
wherein, in a low-load, low-revolution-speed operating state of the internal combustion engine, the electromagnetic fuel injection valve is controlled in accordance with a pulse width prevailing below an idling point.

4. The internal combustion engine control device according to claim 3, wherein the electromagnetic fuel injection valve is configured so that when adjusted, the dynamic flow q0 is equal to qm÷Qstm×Qst÷y×x.
